(19) United States
(12) Patent Application Publication
(10) Pub. No.: US 2008/0118685 A1
(43) Pub. Date: May 22, 2008

(54) Preformed packaging sachet, in particular for food products

(75) Inventor: Bertrand Desmarescaux, Reims (FR)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: ALPEM, Reims (FR)

(21) Appl. No.: 11/985,116

(22) Filed: Nov. 14, 2007

(30) Foreign Application Priority Data
Nov. 16, 2006 (FR) 0654930

(51) Int. Cl. B29D 22/00

(52) U.S. Cl. 428/35.2

(57) ABSTRACT

An embodiment of a preformed packaging sachet for receiving products, in particular food products, is provided with a closing device. The sachet has an opening bounded by a lip provided with an adhesive-coated strip, covered with a protective strip which is removed before adhesive-bonding to close the sachet. On the other side of the opening is another lip that is folded down against the outer face of the sachet as supplied, and that is intended to be folded up and adhesively bonded to the adhesive-coated lip in order to close the sachet.

### CROSS REFERENCE TO RELATED APPLICATION

This application claims benefit of French Patent Application No. 06 54 930, filed Nov. 16, 2006, the disclosure of which is incorporated herein by reference in its entirety.

### FIELD OF THE INVENTION

The present invention relates to a preformed packaging sachet which is provided with a closing device for receiving products, in particular food products, and whose opening is bounded by a face which is provided with an adhesive-coated strip, covered with a protective strip which is removed before adhesive-bonding with respect to the other face in order to close the sachet.

### PRIOR ART

Preformed packaging sachets of the type described above are already known. These sachets are generally produced from two sheets of film or a composite material, cut in a rectangular format and welded at three sides, the fourth side constituting the opening. One face of the sachet which bounds the opening is provided with an adhesive-coated strip which is protected by a band of silicone-coated paper in order to protect the adhesive-coated strip. After having introduced the product into the sachet, the protective band is removed in order to allow the other face to be adhesively-bonded with respect to the strip which is coated with adhesive in this manner.

These sachets are used in particular in retail food commerce for receiving fresh products which are cut up, such as fish or meat. Unfortunately, when introducing the products into the sachet, the surface of the sachet which bounds the opening and which is not coated with adhesive, that is to say, protected by the silicone-coated strip, becomes soiled with the result that this damp or soiled surface will adhesively-bond to the adhesive-coated strip poorly or only with difficulty in order to close the sachet. When the sachet contains a non-neutral product such as fish or cheese, it is desirable for it to be closed in a relatively hermetic manner during transport and/or during storage in a refrigerator.

Unfortunately, this hermetic state is rarely ensured owing to the poor adhesive-bonding of the closing device, one portion of which may sometimes be soiled as indicated.

This sachet also has the disadvantage of being relatively difficult to open when it is in the flat state since the two faces which bound the opening are often pressed one against the other simply by the adhesive nature of the material; it is difficult to open the sachet rapidly and simply, particularly if the user has wet hands or is wearing gloves as is the case at retail points of sale for meat, fish, cheese.

Ease of opening is a significant factor in the rapidity of service for customers.

Furthermore, if the opening operation is difficult to carry out, the sachet may be crumpled which does not present a good brand image, particularly if the sachet is identified with a promotional image or mark, and the contents may also be damaged.

### SUMMARY

One object of certain embodiments of the present invention is to develop a preformed packaging sachet which is provided with a closing device and which is able to be opened simply and rapidly and allows durable closing to be provided, ensuring the tightness of the closing.

To this end, one embodiment of the invention relates to a sachet as mentioned above, in which the opening is extended, on one side, by a lip which is provided with an adhesive strip which occupies the entire length of the opening and which is protected by a removable strip, before adhesive-bonding, and, on the other side, by another lip which is folded during production against the outer face of the sachet and which is intended to be adhesively-bonded to the adhesive-coated lip in order to close the sachet.

The lip or flap formed in this manner by means of prefolding during production can be protected by this surface which will subsequently be adhesively-bonded with respect to the adhesive-coated strip since it will not be in direct contact with the products which are placed in the sachet, so that the risk of it becoming soiled and adhesively-bonding to the adhesive-coated strip poorly can be less.

This lip which is folded on the upper portion of the flattened sachet can also promote the removal of the sachet from a stack of sachets placed in a box or a distributor provided for a counter or, more generally, the point of sale.

Furthermore, the folding of the lip does not impede the application of the adhesive strip over the entire length of the lip, as far as the edge thereof and as far as the folding line. The adhesive-coated strip which extends as far as the two edges of the sachet, can allow the opening to be correctly sealed in a tight manner after the lip which has not been coated with adhesive has been folded down.

In order to promote the removal of the protective strip, it is advantageous for one of the corners or preferably the two outer corners of the adhesive-coated lip to be truncated and for the protective strip to extend as far as this truncated zone whilst remaining inside the geometric contour of the sachet in order to facilitate the gripping of this adhesive-coated strip and the removal thereof after the products have been placed in the sachet in order to be closed subsequently.

The folded lip can also strengthen the edge of the opening of the sachet and thus promote the introduction of the product: in order to introduce the product, it is possible to press on the adhesive-coated lip which rests in a flat state on the counter or a tray whilst, with the other hand, using a finger, the edge formed by the fold of the folded lip is moved apart and is thus relatively rigid in the transverse direction and provides a good level of strength for being raised without the risk of the folded lip folding down automatically or mechanically on the product and becoming soiled. The product slides readily into the sachet without any rough portions or reliefs of the product which might become lodged deforming the edge of the lip, since this edge is folded down and the opening of the sachet thus has a double thickness in the region of the fold.

### BRIEF DESCRIPTION OF THE FIGURES OF THE DRAWINGS

The present invention will be described in greater detail below with reference to embodiments which are schematically illustrated in the appended drawings, in which:

FIG. 1 is an isometric view of a preformed packaging sachet according to the invention, in a flat state before being opened,

FIG. 2 is a partial plan view of a corner of a sachet in the flat state according to FIG. 1,

FIG. 3 is an isometric view of the corner of the sachet from which the protective strip is beginning to be removed from the adhesive-coated lip,

FIG. 4 is a schematic side view of a stack of sachets according to FIG. 1,

FIG. 5 illustrates the deformation of the opening of the sachet of FIG. 1 for receiving a product,

FIG. 6 illustrates the sachet of FIG. 5 closed after introduction of the product.

### DESCRIPTION OF EMBODIMENTS OF THE INVENTION

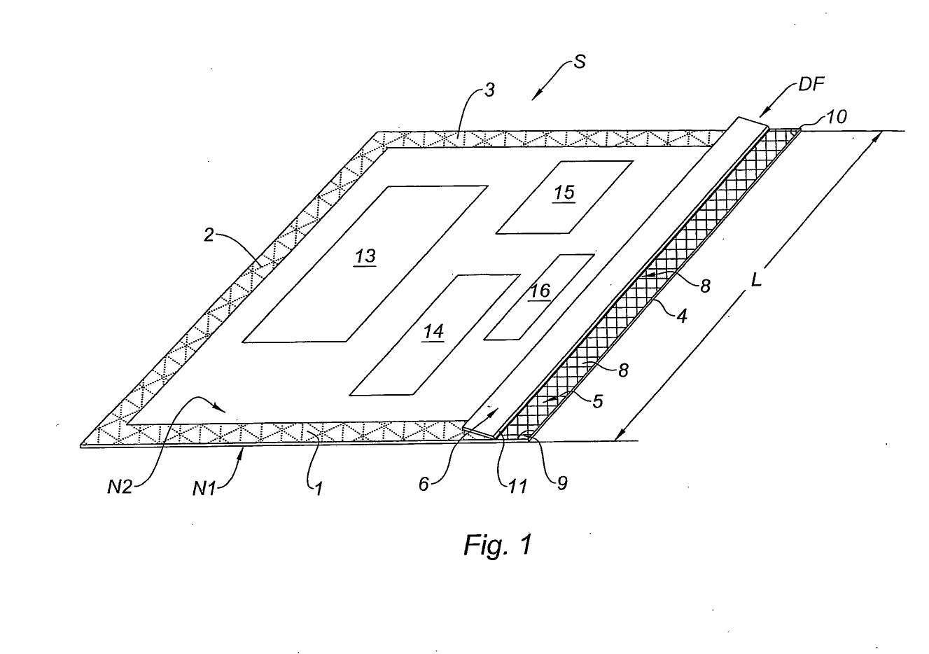

According to FIGS. 1, 2, 3, there is shown an embodiment of a packaging sachet S which is preformed and which is provided with a closing device DF. This packaging sachet S is intended to receive products, in particular fresh food products such as meat, fish, cheese, and must be able to be closed in a tight manner in order to prevent odors released by the products packaged in this manner from spreading in a basket, shopping bag or in the refrigerator when the sachet is temporarily stored therein prior to consumption of the product.

The sachet S according to the example has a rectangular shape. It is composed of two sheets N1, N2 of a single or composite film which is, for example, metal-coated; the sheets are welded at three sides 1, 2, 3 with the fourth side 4 being left open. The opening O is bounded by a first lip 5 which is located in the continuation of one of the faces N1 of the sachet S. This lip 5 occupies the entire width L of the opening O and is in the form of a strip. This first lip 5 carries an adhesive strip or adhesive-coated strip 7, in front of a lip 6 (FIG. 3) and protected by a silicone-coated strip 8 so as not to adhesively-bond before the sachet S is closed.

The two corners 9, 10 of this lip 5 are truncated but the protective strip 8 covers the truncated zone inside the geometric contour of the flat sachet, that is to say, the rectangular shape of this sachet according to this example. This contour has not been identified with a reference numeral.

The truncated portions of the corners 9, 10 afford easier access to a corner of the adhesive strip 8 in order to remove the adhesive strip and to allow the sachet to be closed.

The other lip or second lip 6 which is intended to co-operate with the adhesive-coated lip 5 is folded outwards around a folding line 11. This folding is carried out at the time at which the sachet S is produced in the form as indicated in FIG. 1. The face of the lip 6 that will be subsequently fixed to the adhesive-coated strip is turned upwards.

The sachet S carries, on one of the faces or the two different faces thereof, indications 12-16, marks, logos, instructions for use, etcetera, which are indicated by rectangles.

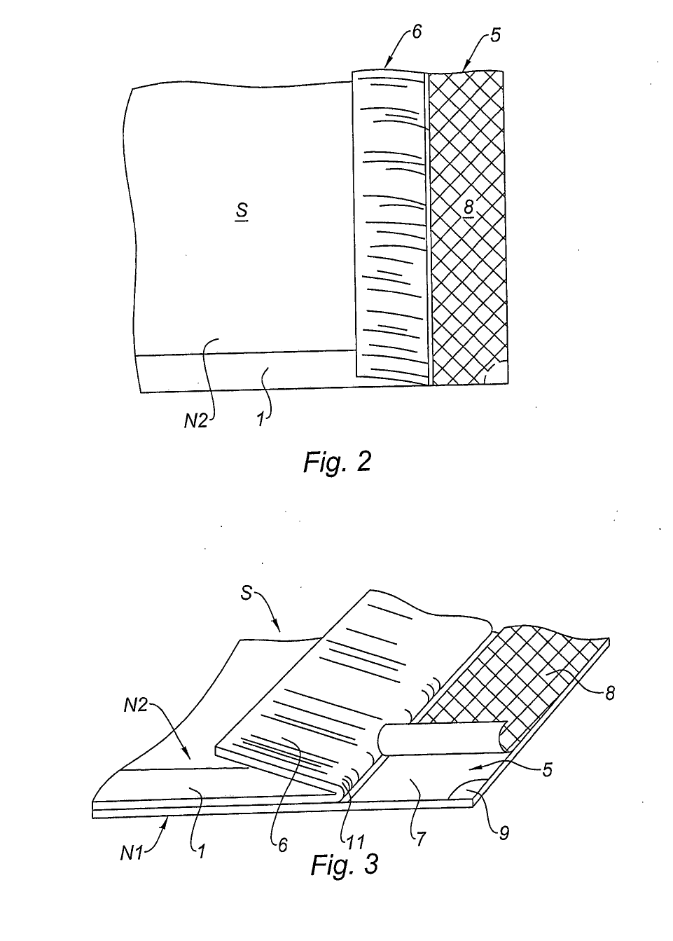

FIGS. 2 and 3 illustrate the arrangement for sealing the sachet in greater detail.

In this manner, in FIG. 2, the adhesive-coated zone 7 is covered with the silicone-coated strip of paper 8, schematically indicated with cross-hatching. The lip 6 which is folded about the folding line 11 thereof is highlighted with transverse hatching. The corner 9 of the adhesive-coated lip 5, which corner may optionally be truncated, is illustrated with a dashed contour.

FIG. 3 illustrates how the silicone-coated strip 8 which protects the adhesive strip 7 is removed from the adhesive-coated lip 5.

This Figure also illustrates that the adhesive-coated strip 7 extends as far as the edge of the weld seam of the side 1, which edge of the weld seam corresponds to the folding line 11.

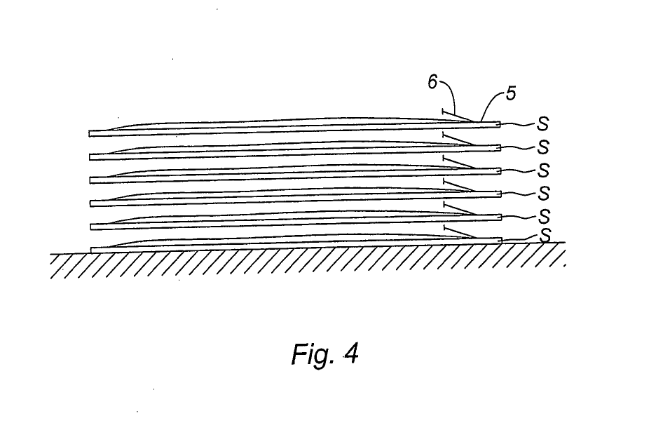

FIG. 4 schematically illustrates a stack of sachets S leaving production or in the state in which they are provided for the user.

The sachets are stacked in the manner in which they leave production, with the non-adhesive-coated lip 6 folded. The entire stack is packaged in parcels in boxes or presentation packages so as to be accessible, preferably from above.

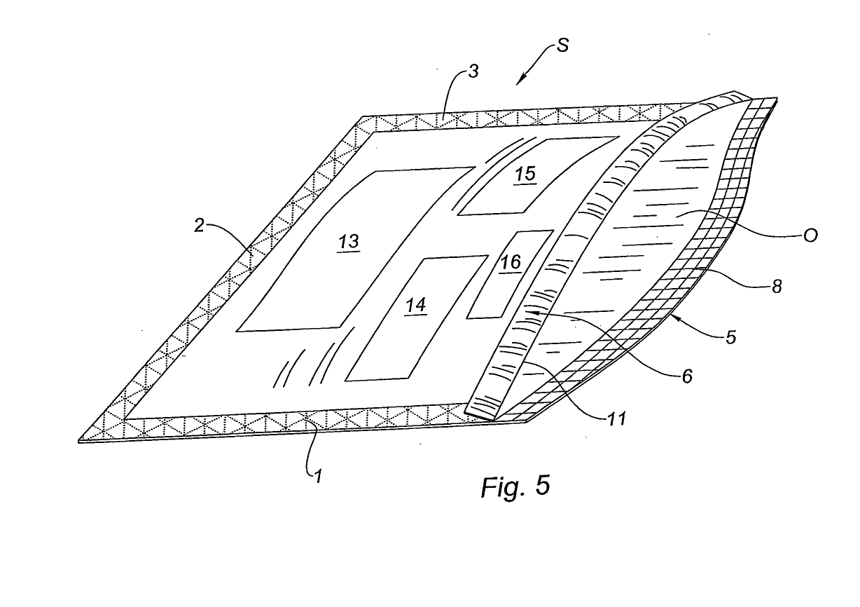

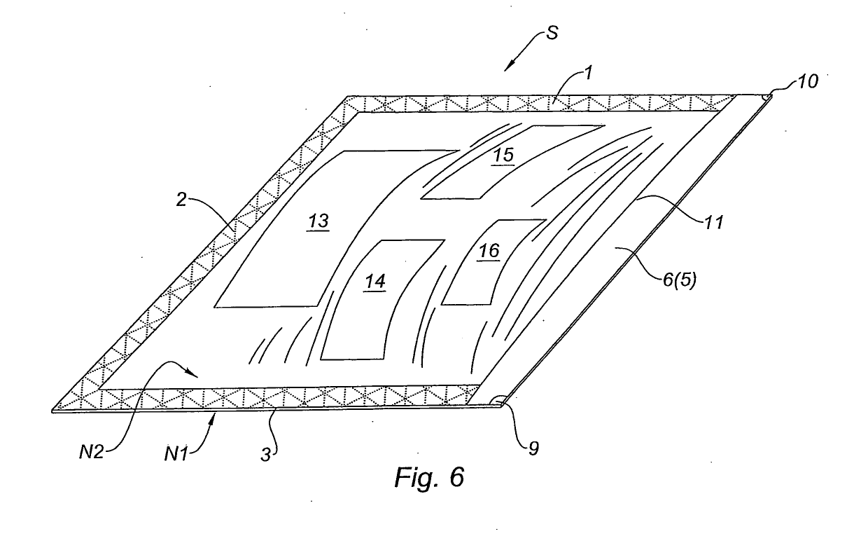

FIG. 5 schematically illustrates the shape that the sachet S has when the two lips 5, 6 are moved apart in order to introduce a product into the sachet. From this Figure, it can clearly be seen that it is possible to press on the adhesive-coated lip 5, by pressing on the protective strip 8, and by moving apart or raising the other lip 6 in order to form an opening in the form of a lozenge. When the product is introduced, since the non-adhesive-coated lip 6 is folded outwards and owing to the very deformation as seen in FIG. 5, there is no risk of the lip automatically folding forwards and it remains well outside any contact zone with the product that is introduced into the sachet. Under these conditions, the surface of this lip 6 which is intended to be connected to the adhesive-coated strip 7 is not at risk, or is at reduced risk, of becoming soiled as a result of contact with the product which is placed in the sachet.

After this positioning, it is sufficient to remove the protective strip 8 from the adhesive-coated lip 5 and fold down the other lip 6, for example, by simply moving a hand over the top of the sachet in order to fold down the second lip 6 with respect to the adhesive-coated lip 5, and then to press along the length of the second lip 6 in order to close the sachet in a tight manner. Since the adhesive-coated strip 7 extends as far as the two sides of the lip and to the spliced joint of the two lips, at the end of the welded zone of each of the two sides of the sachet which terminate at the folding line, the closing will be almost tight.

FIG. 6 illustrates the sachet in a closed state.

The product is correctly enclosed in the sachet and prevents other products which are transported or stored at the same time from becoming contaminated by odors.

What is claimed is:

1. A preformed packaging sachet provided with a closing device for receiving products, comprising:
first and second faces bounding an opening;
a first lip on the first face that occupies the entire length of the opening;
an adhesive-coated strip on the first lip that occupies the entire length of the opening;
a removable protective strip covering the adhesive strip;
a second lip on the second face that occupies the entire length of the opening and that is folded against the second face of the sachet;
wherein in use the protective strip is arranged to be removed and the second lip is arranged to be folded out to enable adhesive bonding of the second lip with the adhesive strip on the first lip in order to close the sachet.

2. Preformed packaging sachet according to claim 1, further comprising two sheets that are welded at three sides.

3. Preformed packaging sachet according to claim 1, wherein the first and second faces comprise metal-coated sheets.

4. Preformed packaging sachet according to claim 1, wherein the two lips extend as far as outer edges of the sachet in the region of the opening and the adhesive-coated strip extends as far as the two edges.

5. Preformed packaging sachet according to claim 1, wherein at least one outer corner of the first lip ends inward of an outer contour of the sachet and the protective strip extends beyond said at least one outer corner of the first lip within the outer contour of the sachet.

6. A preformed packaging sachet provided with a closing device for receiving products, wherein
the sachet has an opening bounded by a face that is provided with an adhesive-coated strip and another face;
the adhesive strip is covered with a protective strip that is removed before adhesive bonding with respect to the other face in order to close the sachet;
the opening is extended, on the one side, by a lip which is provided with the adhesive strip that occupies the entire length of the opening and is protected by the removable strip, before adhesive-bonding, and, on the other side, by the other lip that is folded during production against the outer face of the sachet and which is intended to be adhesively-bonded to the adhesive-coated lip in order to close the sachet.

7. Preformed packaging sachet according to claim 6, that is composed of two sheets which are in particular metal-coated and which are welded at three sides.

8. Preformed packaging sachet according to claim 6, wherein the two lips extend as far as the outer edges of the sachet in the region of the opening thereof and the adhesive-coated strip extends as far as the two edges.

9. Preformed packaging sachet according to claim 6, wherein at least one of the outer corners of the lip provided with the adhesive-coated strip is truncated and the protective strip which covers the adhesive-coated strip overlaps the truncated portion inside the contour of the sachet.
